(19) United States
(12) Patent Application Publication
(10) Pub. No.: US 2009/0038189 A1
(43) Pub. Date: Feb. 12, 2009

(54) Selective backlight

(75) Inventor: Herbert Jan Karl Boks, Alpen Aan Den Rijn (NL)

Correspondence Address: QUINN LAW GROUP, PLLC, 39555 ORCHARD HILL PLACE, SUITE # 520, NOVI, MI, 48375, US

(73) Assignee: Estrakon Inc., Ann Arbor, MI (US)

(21) Appl. No.: 12/151,654

(22) Filed: May 8, 2008

Related U.S. Application Data
(60) Provisional application No. 60/924,337, filed on May 9, 2007.

(51) Int. Cl. G09F 13/18

(52) U.S. Cl. 40/546

(57) ABSTRACT

A composition relating to the field of signage, comprising of one or more layers of panel and sections therein, which are stacked uniformly with various inclusions or exclusions on, in or adjacent to the panels and with a light source placed parallel to an edge of each panel. When illuminated, there is a light effect of animation visible on the front surface of the sign which is created by the inclusions and articles within the composition and varying the illumination of the light source.

### CROSS-REFERENCE TO RELATED APPLICATIONS

Listed below are patent of similar art and generally relating to the subject mater of the invention at hand:
U.S. Pat. No. 3,665,626 A May 1972 Lund et al. (40/570)
U.S. Pat. No. 3,752,974 A August 1973 Baker et al.
U.S. Pat. No. 3,761m703 A September 1973 Mund et al.
U.S. Pat. No. 3,892,959 A July 1975 Pulles
U.S. Pat. No. 3,906,650 A September 1975 Coffinan (40/552)
U.S. Pat. No. 3,958,113 A May 1976 Termohlen
U.S. Pat. No. 4,043,636 A August 1977 Eberhardt et al (349/65)
U.S. Pat. No. 4,118,111 A October 1978 Laesser
U.S. Pat. No. 4,177,501 A December 1979 Karlin
U.S. Pat. No. 4,183,628 A January 1980 Laesser et al. (349/65)
U.S. Pat. No. 4,257,084 A March 1981 Reynolds (362/31)
U.S. Pat. No. 4,271,408 A June 1981 Teshima et5 al. (345/83)
U.S. Pat. No. 4,282,560 A August 1981 Kringel et al.
U.S. Pat. No. 4,290,093 A September 1981 Thompson et al.
U.S. Pat. No. 4,310,219 A January 1981 Jaccard (359/599)
U.S. Pat. No. 4,384,343 A May 1983 Plumly (362/31)
U.S. Pat. No. 4,446,508 A May 1984 Kinzie
U.S. Pat. No. 4,542,449 A September 1985 Whitehead
U.S. Pat. No. 4,573,766 A September 1985 Boumay, Jr. et al.
U.S. Pat. No. 4,630,895 A December 1986 Abdala, Jr. et al.
U.S. Pat. No. 4,714,983 A December 1987 Lang
U.S. Pat. No. 4,729,185 A March 1988 Baba
U.S. Pat. No. 4,751,615 A June 1988 Abrams
U.S. Pat. No. 4,763,984 Awai et al. (385/31)
U.S. Pat. No. 4,765,701 A August 1988 Cheslak
U.S. Pat. No. 4,791,540 A December 1988 Dreyer et al. (362/331)
U.S. Pat. No. 4,811,507 A March 1989 Blanchet (40/546)
U.S. Pat. No. 4,845,596 A July 1989 Mouissie (362/560)
U.S. Pat. No. 4,885,663 A December 1989 Parker (362/561)
U.S. Pat. No. 4,890,201 A December 1989 Toft (362/31)
U.S. Pat. No. 4,906,070 A March 1990 Cobb, Jr.
U.S. Pat. No. 4,907,132 A March 1990 Parker (362/556)
U.S. Pat. No. 4,961,617 A October 1990 Shahidi et al. (385/31)
U.S. Pat. No. 4,974,122 A November 1990 Shaw
U.S. Pat. No. 4,975,808 A December 1990 Bond et al.
U.S. Pat. No. 4,978,952 A December 1990 Irwin (345/102)
U.S. Pat. No. 5,005,108 A April 1991 Pristash et al. (362/31)
U.S. Pat. No. 5,009,019 A April 1991 Erlendsson et al. (40/541)
U.S. Pat. No. 5,009,483 A April 1991 Rockwell III (385/116)
U.S. Pat. No. 5,027,258 June 1991 Schoniger et al. (362/31)
U.S. Pat. No. 5,036,435 A July 1991 Tokuda et al. 362/31
U.S. Pat. No. 5,050,946 September 1991 Hathaway et al. (385/33)
U.S. Pat. No. 5,056.892 A October 1991 Cobb, Jr.
U.S. Pat. No. 5,070,431 A December 1991 Kitazawaetal. (362/31)
U.S. Pat. No. 5,075.826 A December 1991 Lan (362/541)
U.S. Pat. No. 5,079, 675 A January 1992 Nakayama (362/31)
U.S. Pat. No. 5,093,765 A March 1992 Kashima et al.
U.S. Pat. No. 5,106,181 A April 1992 Rockwell III (385/2)
U.S. Pat. No. 5,124,890 A June 1992 Choi et al. (362/27)
U.S. Pat. No. 5,134,549 A July 1992 Yokoyama
U.S. Pat. No. 5,136,480 A August 1992 Pristash et al. (362/31)
U.S. Pat. No. 5,136,484 A August 1992 Schoniger et al
U.S. Pat. No. 5,150.965 A September 1992 Fox (362/260)
U.S. Pat. No. 5,165,187 A November 1992 Shahidi-Hamedani et al. (40/547)
U.S. Pat. No. 5,178,447 January 1993 Murase et al.
U.S. Pat. No. 5,205,493 A May 1993 Murase et al.
U.S. Pat. No. 5,262,928 Kashima et al.
U.S. Pat. No. 5,276,591 A January 1994 Hegarty (362/601)
U.S. Pat. No. 5,283,673 February 1994 Murase et al.
U.S. Pat. No. 5,303,322 A April 1994 Winston et al.
U.S. Pat. No. 5,307.244 A April 1994 Gaudette
U.S. Pat. No. 5,339,179 A August 1994 Rudisill et al.
U.S. Pat. No. 5,349,506 A September 1994 Blonder et al.
U.S. Pat. No. 5,375,043 A December 1994 Tokunaga
U.S. Pat. No. 5,377,084 A December 1994 Kojima et al. (362/31)
U.S. Pat. No. 5,386,347 A January 1995 Matsumoto (362/31)
U.S. Pat. No. 5,390,085 A February 1995 Mari-Roca et al.
U.S. Pat. No. 5,394,308 A February 1994 Watanabe et al.
U.S. Pat. No. 5,396,350 A March 1995 Beeson et al. (349/62)
U.S. Pat. No. 5,414,947 A May 1995 Hjaltason (40/615)
U.S. Pat. No. 5,428,468 A June 1995 Zimmerman et al. (349/62)
U.S. Pat. No. 5,442,523 A August 1995 Kashima et al.
U.S. Pat. No. 5,4442932 A August 1995 Jeroma (40/564.
U.S. Pat. No. 5,467,208 A November 1995 Kokawa et al.
U.S. Pat. No. 5,467,417 A November 1995 Nakamura et al.
U.S. Pat. No. 5,485,291 A January 1996 Qiao et al.
U.S. Pat. No. 5,506,929 A April 1996 Tai et al.
U.S. Pat. No. 5,521,342 A May 1996 Barley et al.
U.S. Pat. No. 5,536,558 A July 1996 Shelton (428/167)
U.S. Pat. No. 5,555,329 A September 1996 Kuper et al. (385/36)
U.S. Pat. No. 5,576,078 A November 1996 Shatz (428/13)
U.S. Pat. No. 5,579,134 A November 1996 Lengyel
U.S. Pat. No. 5,590.945 A January 1997 Simms
U.S. Pat. No. 5,598,281 A January 1997 Zimmerman et al. (349/5)
U.S. Pat. No. 5,600.462 A February 1997 Suzuki et al.
U.S. Pat. No. 5,618,095 A April 1997 Kashima et al.
U.S. Pat. No. 5,649,754 A July 1997 Matsumoto
U.S. Pat. No. 5,664,862 A September 1997 Redmond et al.
U.S. Pat. No. 5,671,994 A September 1997 Tai et al.
U.S. Pat. No. 5,711,592 A January 1998 Hotta
U.S. Pat. No. 5,719,649 A February 1998 Shono et al.
U.S. Pat. No. 5,771,328 A September 1998 Wortman et al.
U.S. Pat. No. 5,885,791 A July 1998 Yoshikawa et al.
U.S. Pat. No. 5,799,337 A July 1998 Saito et al.
U.S. Pat. No. 5,799,338 A July 1998 Ishikawa et al
U.S. Pat. No. 5,808,784 A September 1998 Ando et al.
U.S. Pat. No. 5,844,720 A December 1998 Ohara et al.
U.S. Pat. No. 5.890,791 A April 1999 Saito
U.S. Pat. No. 5,917,664 A June 1999 O'Neill et al.
U.S. Pat. No. 5,919,551 A July 1999 Cobb, Jr. et al.
U.S. Pat. No. 5,931,555 A August 1999 Akahane et al.
U.S. Pat. No. 5,961,198 A October 1999 Hira et al.
U.S. Pat. No. 5.971.559 A October 1999 Ishikawa et al.
U.S. Pat. No. 6,011,602 A January 2000 Miyahita et al.
U.S. Pat. No. 6,036.329 A March 2000 Iimura
U.S. Pat. No. 6,091,547 A July 2000 Gardiner et al.
U.S. Pat. No. 6,120,280 A September 2000 Mimura et al.
U.S. Pat. No. 6,130,730 A October 2000 Jannson et al.
U.S. Pat. No. 6,151m169 A November 2000 Kim
U.S. Pat. No. 6,172,809 B1 January 2001 Koike et al.
U.S. Pat. No. 6,745,506 B1 May 2004 Maas et al (40/546)
Foreign Patent Documents
0 453 092 A1 October 1991
341968 January 1931
WO 96/17207 June 1996
7086770, 7024809, 6988820, 6591530, 6205690, 7108414, 5295221, 6893135, 5842297, 4949489

### FIELD OF THE INVENTION

This invention relates to illuminated signage, and particularly to specific articles and methods and articles related to a manner of backlighting.

### DESCRIPTION OF BACKGROUND

Before the current invention, the commercial advantage of using illuminated displays has been widely known in several fields of industry. Illuminated Displays have been used in the entertainment and advertisement, among other fields. Many variations in relevant technology have been in common use over time. The main advancement of the technology in this specific field is to improve the control of the light within the composition to create advancements of the light effects possible in the art.

### SUMMARY OF THE INVENTION

As recognized in previous disclosures, the problems to be addressed in constructing illuminated signage include creating a more visually pleasing product by increasing versatility of signage with the light effect of animation, color and brightness. The current invention proposes to further improve the art in this field by creating more efficient isolation of light to better create the light effect of animation. This will be achieved through the selective backlight of various areas of surfaces with in the current invention.

The selective backlighting is achieved by taking panels that can be made of a material such as acrylic resin with inclusion or exclusion on, in or adjacent to the panel and isolating specific parts of surface by cutting sections in the panel, separating those sections with various articles, not limited to, but including tape, masking devices and separators. Then, these separate panels can be put together in specific manner to be illuminated by means of edge lighting. Different sections of the surface of the sign have the ability to be lit separately. This method, coupled with their manner of surface inclusions and exclusions, thus creates the light effect of animation.

Specific articles and methods corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECT OF INVENTION

The technical effects of the current invention on its field is that it creates a superior product by creating greater control of the light within the composition by the methodology of construction and use of specific articles as outlined in the detailed description.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of an exploded view of a specific article of signage with detail of the corresponding articles relating to the current invention.

FIG. 2 illustrates one example of stages of light variations with in a complete display, in order to demonstrate the light effect of animation within the composition.

FIG. 3 illustrates one example of a partially exploded and side view of second embodiment of the display; in which, the panels are sheets that have been separated.

FIG. 4 illustrates one example of the second embodiment of the current invention, wherein the left section is illuminated and wherein the panels are cut apart and isolated in order to facilitate the light effect of animation by allowing the separated panels to be lit individually.

FIG. 5 illustrates one example of a second embodiment of the current invention, wherein the right section is illuminated.

The detailed description explains the preferred embodiments of the invention, together with advantages and features, by way of example with reference to the drawings.

### DETAILED DESCRIPTION OF THE INVENTION

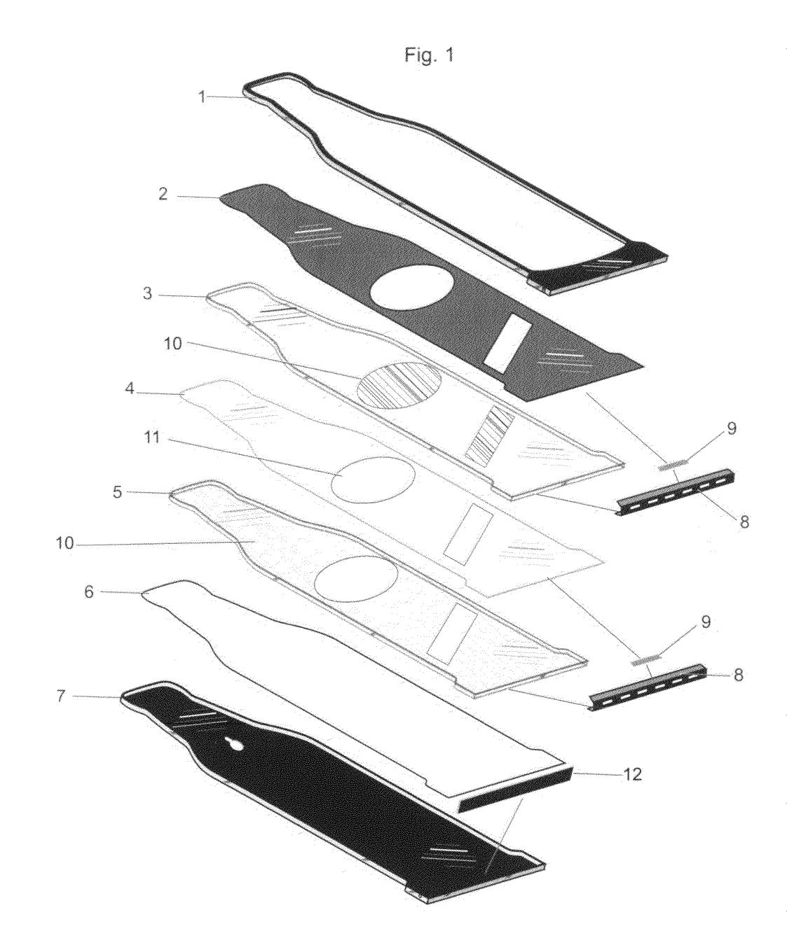

Turning now to the drawings in greater detail, it will be seen that in FIG. 1 there is an exploded view of an embodiment of the current invention. Visible here are the articles of the composition of the current invention. Specifically, the current invention is composed of multiple layers of panels and other articles which are described in greater detail below.

The panels are edgelit and operate on the principle of Total Internal Reflection and diffusely reflective markings to extract light from the panels in desired areas. The light effects are achieved by illuminating each panel with one or more separate light sources that are individually controllable.

The major visual article within the composition is a partially or full transparent panel with a specific representation of a graphic image (2). This panel may be coupled with a light-diffusing surface which will be described in greater detail below. This panel can be placed behind some other layers or be the front most layer based on the light effect for the specific project. For instance, the first embodiment displays a bottle; a layer consisting of an acrylic panel (3) as described below can be placed in behind of the graphic panel (2) and marked as described below to create the effect of bubbles rising in the bottle, among other possible effects.

Other panels (3) are marked with specific markings, which vary depending on the requirements of the individual project; panels can be marked with these specific markings (10) on, in or adjacent to the panel surface. These markings are applied in a manner so that they are diffusely reflective; thus, light contained with in the panel is visible at the point of the etching because the etching has different refractive angle than the plane of the panel. Panels can be constructed of material such as acrylic resin and must be transparent in order to facilitate the light effect.

Above mentioned markings (10) consist of various shapes and sizes. Markings can be specularly-reflecting material and may be deposited on the surface of the panel in various manners including printing, etching into the surface of the panels or other similar processes. Additionally, a transparent sheet (4) with such markings can be placed adjacent to the broad surface of one or all of the panels in order to facilitate the light effect.

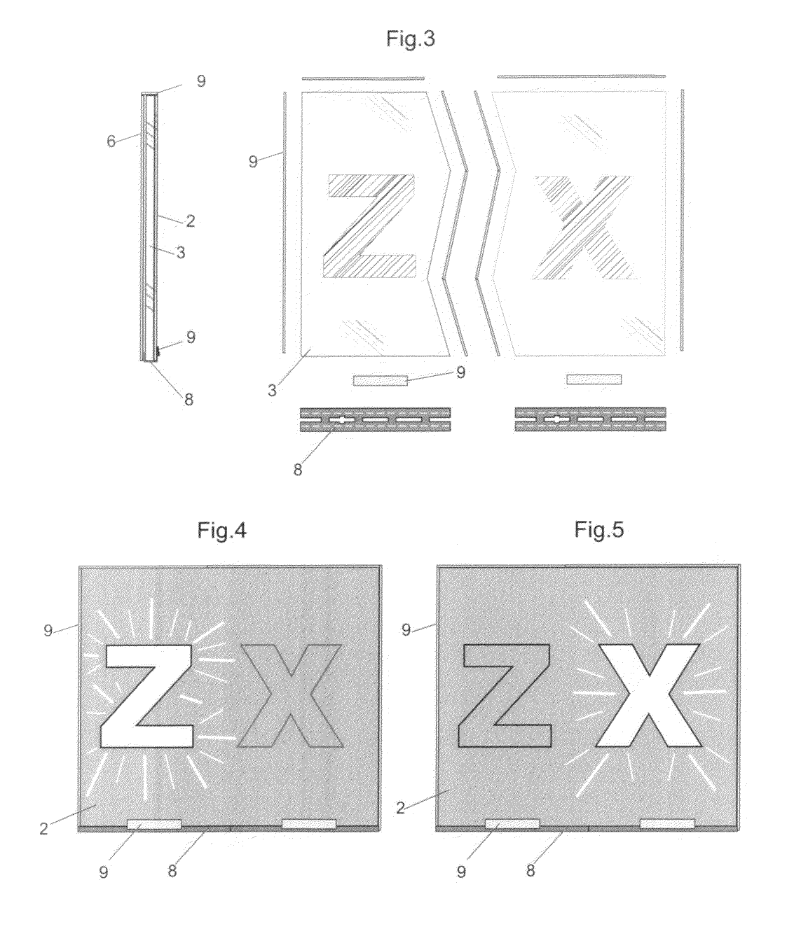

FIG. 3 through FIG. 6 show a second embodiment of the current invention. Depending on the desired light effect requisite for a specific project, panels may also be broken and isolated into sections of varying shapes and sizes to facilitate the clarity of the light effect by maximizing the amount of light focused through the panel and limiting the light from bleeding across adjacent panels. Panels can be isolated by various means, including various types of tape or paint around the narrowest edge or side of the panel. Dependent on the requirements of the specific project, panels can be: attached, by various means including various types of tape (9), to each other to preserve continuity in the design; placed adjacent to each other as corresponds to the design; or, placed with spaces in between them and sandwiched between one or more layers of panels.

In either embodiment the quality of the light effect can be facilitated with: various masks (5), reflective surfaces 6), diffusers and separators (8) can be used to improve the quality of light intensity and focus throughout the sign. For instance, reflective surfaces can be placed behind some, all or sections of the panels, depending on the requirements of the specific project. Conversely, dark masks of varying opaqueness can be places behind some, all or sections of the panels depending on specific requirements of the project. Separators are used in varying ways to facilitate the light focus and intensity; they can be made of various materials depending on the requirement of the project.

Above mentioned articles facilitate the ability to isolate light into specific parts of the sign and either provide light or block light to other sections of the surface of the composition at the same time, and allowing the ability to light different parts of the sign at different intensities, thus further improving the light effect of animation. For instance, they can create the effect of a watermark or an independently light grouping of words or graphic representation. All articles discussed here are further explained below.

Masks (5) can be various articles made of various materials that have non-reflective properties and vary in opaqueness in order to facilitate the control of the amount of light. Masks can consist of transparent film, paper or similar material with various shades of the color scale printed on there surface; they can also be constructed with a material with requisite opaqueness. The shades are selected to create the desired light effect as is requisite for the specific project. Masks can be on, attached to or adjacent to the requisite panel depending on the requirements of the specific project.

Reflective surfaces (6) can be various articles make of various materials that have specularly-reflective surfaces in order to intensify the intensity of brightness thus facilitating the overall light effect. The reflective surfaces can consist of reflective papers, films and similar articles. Reflective surfaces can be on, attached to or adjacent to the requisite panel depending on the requirements of the specific project.

Separators(8) can be various articles made of materials such as paper, metal among other similar articles. They are employed to separate light sources going to different panels as to prevent light intended for one panel to bleed across others. The separators can be places between or adjacent to any edge of the panels and are selected as is requisite for the specific project's desired light effect.

Light diffusers can be located behind the front-most or any other graphic panel. They control the amount of light across the visible surface of the panel by distributing the light evenly. Light diffusers can be made out of many materials including various resins.

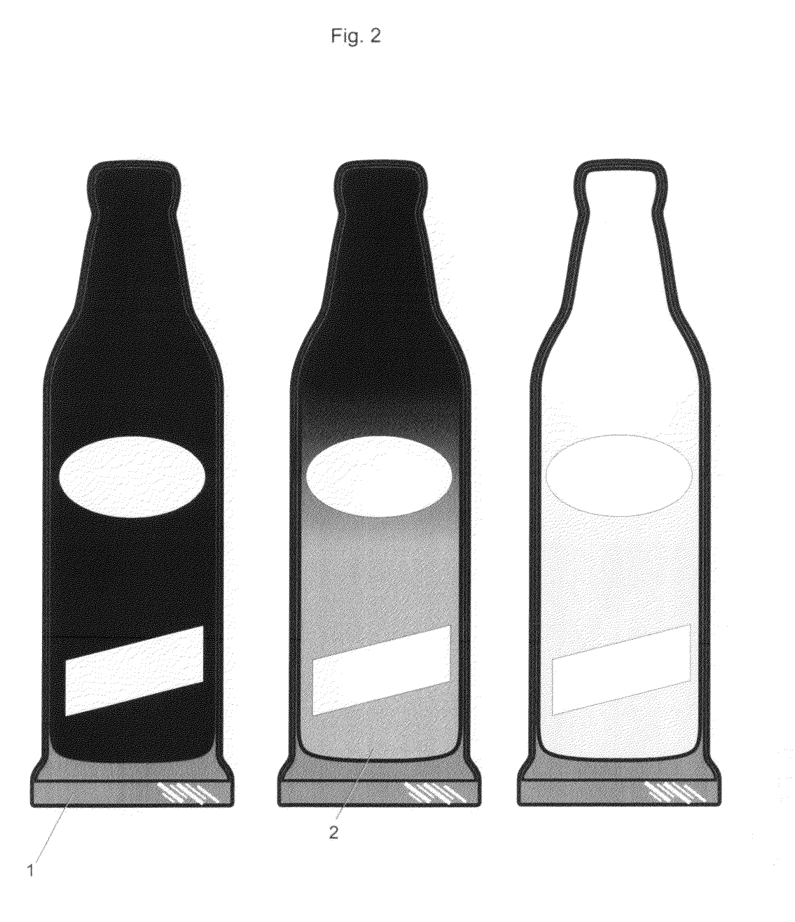

The light source (12) consists of one or more surfaces, containing illuminating articles of various types, placed adjacent to any of the narrowest edges of the sign. Each panel of the composition has its own specific illuminating articles. The light source is controlled by a microcontroller that is programmed with a specific sequence of turning the illuminating articles off and on to produce the desired light effect (FIG. 2). The specific illuminating articles used to light the current invention can consist of, but are not limited to, light emitting diodes (commonly know as LED's) or cold cathode fluorescent lamps (commonly known as CCFL), as light sources. Placement of the light sources is dependent on the requirements of the light effect desired for the specific project.

Methodology of construction of the current invention consists of placing panels, sections of panels, and any requisite articles as discussed above, in a specific manner, usually with the broadest surfaces touching. Order of the articles consisting of the current invention is formulated based on the requirements of the light effect of the specific project. The above discussed articles are stacked either loosely or they can be attached in various manners. The composition of articles can be enclosed in a common frame or without a frame and with a binding substance such as tape or glue to secure the composition of articles.

The present invention can be included in an article of manufacture having possible uses in many commercial fields and private applications such as in the artistic or education fields. The current invention can be included as part of a larger composition, of similar or corresponding compositions, or sold separately.

The capabilities of the present invention can be implemented in specific articles of construction and methodology to create the light effect of animation. For instance, the steps may be performed in a differing order, or steps may be added, deleted or modified depending on the different requirements for the desired effect in relation to each individual project. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described and preserve the spirit of the invention therein.

What is claimed is:

1) An article of signage comprising: A composition of: a partially or fully transparent graphic image and one or more transparent panels stacked together, each panel having selectively diffused areas corresponding to elements of the image/graphic to be illuminated; one or more light sources placed adjacent to any edge of each of the panels.

3) The composition of claim 1 wherein one or more of the stacked panels is cut in sections in such a way that various areas of the one or more panels can be independently illuminated.

4) The composition of claim 1 wherein each light source is comprised of multiple separate light sources. The above mentioned articles consisting of various colors and being intentionally lit by a programed micro controller in order to create light effects in the composition.

5) The composition of claim 1 wherein a partially transparent film is positioned directly behind the panel containing the main graphic representation.

6) The composition of claim 1 wherein a partially transparent film is positioned directly behind the front light source.

7) The composition of claim 1 wherein the panels are placed with articles that focus and intensify the light effect of the composition; specifically: masks, reflective surfaces, light diffusers and separators.

8) The composition of claim 1 where the composition is manufactured in conjunction with similar composition or as a whole, single unit.
